(19) United States
(12) Patent Application Publication
(10) Pub. No.: US 2023/0345163 A1
(43) Pub. Date: Oct. 26, 2023

(54) AUDIO CHARGING CASE

(71) Applicant: Sony Interactive Entertainment Inc., Tokyo (JP)

(72) Inventor: Glenn Black, San Mateo, CA (US)

(21) Appl. No.: 17/725,910

(22) Filed: Apr. 21, 2022

(51) Int. Cl. H04R 1/10; H04R 5/04

(52) U.S. Cl. CPC H04R 1/1041; H04R 1/1025; H04R 1/1091; H04R 5/04; H04R 2420/07

(57) ABSTRACT

A charging case for wireless earbuds is connected to a computer and wirelessly sends audio from the computer to the earbuds, allowing computer audio to be heard without having to pair the earbuds to the computer through Bluetooth or disturbing preexisting Bluetooth connections. Further, computer audio may be merged with audio from a mobile device, the mix of which may be controlled by a control element on the charging case.

### FIELD

The present application relates generally to audio charging cases for wireless earbuds.

### BACKGROUND

As recognized herein, wireless earbuds are a popular tool people use to listen to audio without wires dangling around their necks. The earbuds typically pair via Bluetooth with a portable source of audio such as a mobile phone.

### SUMMARY

As further understood herein, wireless earbuds, like all portable wireless devices, must be associated with a way to charge them, typically using a charging case in which the earbuds can be set. Present principles further understand that such a charging case may be leveraged to increase functionality for the user.

Accordingly, an assembly includes left and right earbuds configured to engage the ears of a person for playing audio. The assembly also includes a charging case configured for charging batteries in the left and right earbuds. The charging case in turn includes at least one processor configured with instructions to send to the earbuds, via at least one wireless interface, signals from a first source of audio representing audio for play of the audio on speakers of the earbuds.

In examples, first source of audio can include, e.g., a laptop computer or other computer or a mobile telephone.

If desired, the charging case may be configured to mix audio from the first source of audio with audio from a second source of audio. In such an embodiment, the charging case can include at least one selector operable by a user to establish the mix of audio.

In some embodiments the charging case is configured to be communicatively connected to the first source of audio.

In example implementations, the charging case is configured with first and second receptacles configured to closely hold the respective left and right earbuds.

In another aspect, a method includes charging left and right earbuds using at least one charging case configured with first and second receptacles configured to hold the respective left and right earbuds. The method further includes providing wireless audio signals from the charging case to the earbuds for playing audio on the earbuds.

In another aspect, a charging case includes at least one contact electrically connected to a power supply in the charging case and configured to engage a contact on an earbud to charge a battery in the earbud, and at least one audio signal path in the charging case for wirelessly sending audio signals to the earbud.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates example earbuds next to an earbud charging case consistent with present principles;

FIG. 3 is a block diagram of an example earbud, charging case, and mobile device consistent with present principles;

FIG. 4 illustrates example logic in example flow chart format consistent with present principles; and

FIGS. 5 and 6 are example screen shots of example user interfaces that may be presented on any display disclosed herein consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation °, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

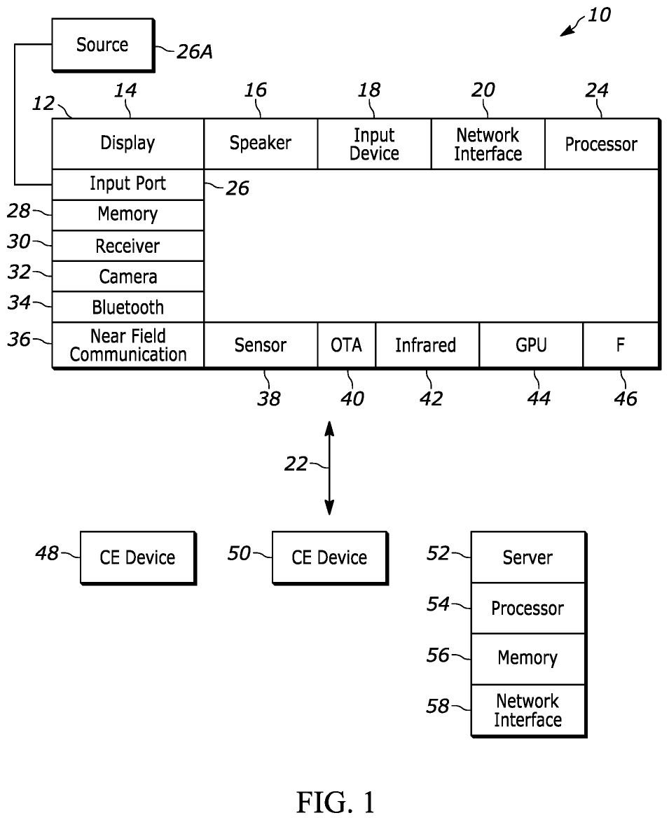

Referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12 and/or CE devices. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

For example, the earbuds and charging case may implement some or all of the components shown for the CE devices in FIG. 1 and can include those specifically shown in the figures about to be described.

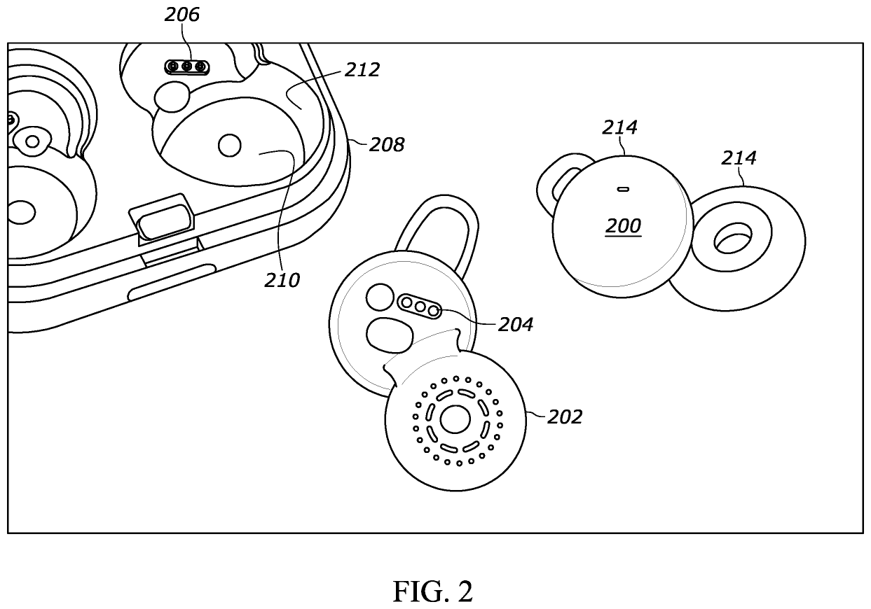

FIG. 2 illustrates left and right earbuds 200 that can receive wireless signals from a source of audio and transform the signals into sound that a person wearing the earbuds can hear. In the example shown, the earbuds 200 are shaped to fit into a respective ear of a person and hence have gently curved external surfaces 202 configured for this purpose.

As shown, each earbud 200 includes at least one and in the example shown three electric al contacts 204 for engaging respective charge contacts 206 of a charging case 208. The charge contacts 206 register with and contact the earbud contacts 204 to charge a battery in the respective earbud when the earbud is disposed in a charge receptacle 210 of the charging case 208. The charge receptacle 210 has a periphery 212 that, as can be appreciated in reference to FIG. 2, matches the outer periphery 214 of an earbud 200 so that the earbud 200 fits snugly within the receptacle 210 while charging.

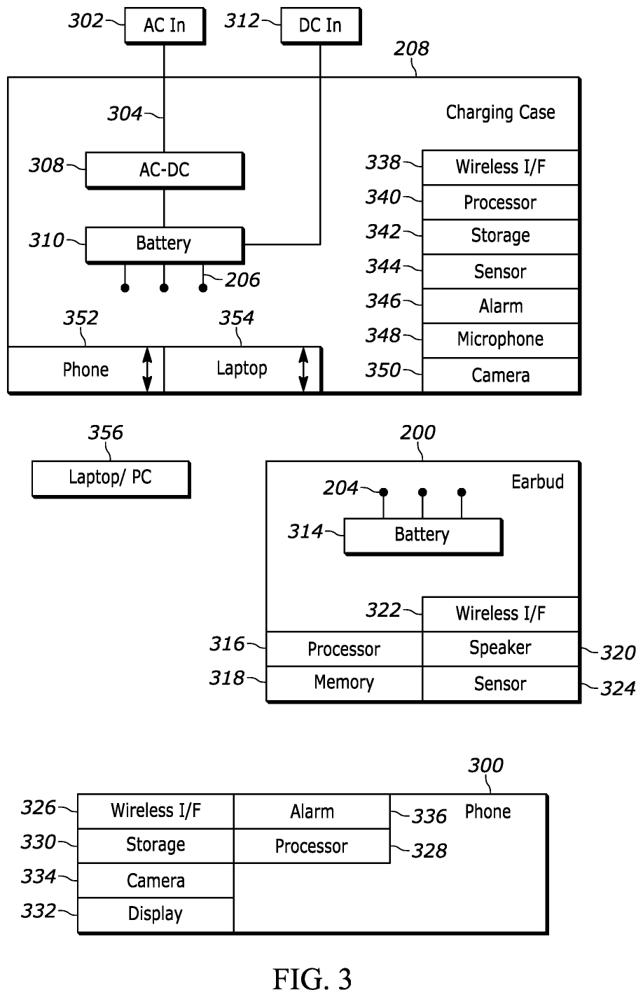

FIG. 3 illustrates example components in the earbud 200 and charging case 208, as well as in an audio source such as a mobile device 300. A source 302 of alternating current (AC) power such as an electrical socket can be engaged via cord 304 with an AC-to-DC converter 306 in the charging case 208. Output of the converter 308 may be used to charge one or more batteries 310 in the charging case in the example non-limiting architecture shown. Also, if desired, a source 312 of direct current (DC) power can be engaged with the charging case 208 to charge the battery 310. In the example architecture shown, the charge contacts 206 are electrically connected to battery 310 to provide DC power through the earbud contacts 204 when the earbud is disposed in the receptacle 210 of the charging case 208 to charge one or more batteries 314 in the earbud 200. It is to be understood that the charging case battery 310 may be omitted and the charging case contacts 206 connected directly to the DC source 312 and/or AC-DC converter 308.

The one or more batteries 314 of the earbud 200 supplies power to one or more processors 316 accessing one or more disk-based or solid-state computer storages 318 in the earbud to play audio on one or more speakers 320 within the earbud 200. The audio may be received via wireless signals through one or more wireless interfaces 322 such as one or more transceivers such as a Bluetooth transceiver and/or Wi-Fi transceiver from a source of audio such as the mobile device 300, which may be configured as a wireless phone. The earbud 200 also may include one or more sensors 324 for purposes to be shortly disclosed.

The mobile device 300 may include one or more wireless interfaces 326 such as one or more transceivers such as a Bluetooth transceiver and/or Wi-Fi transceiver to communicate with the earbud 200. The mobile device 300 also may include one or more processors 328 accessing one or more disk-based or solid-state computer storages 330 that can contain audio tracks. The mobile device 300 may include one or more displays 332, one or more cameras 334, and one or more audible and/or visual and/or tactile alarms 336 that are controlled by the processor 328.

In the example shown, in addition to the charging components discussed above, the charging case 208 may include one or more wireless interfaces 338 such as a Bluetooth and/or Wi-Fi transceiver controlled by one or more processors 340 accessing one or more disk-based or solid-state computer storages 342. The processor 340 also may communicate with one or more sensors 344, one or more audible and/or visual and/or tactile alarms 346, one or more microphones 348, and one or more imagers 350 such as a still or video camera. The charging case 208 may further bear human-manipulable phone and computer selectors 352, 354 for increasing and decreasing the mix of audio played by the earbuds 200 from the mobile device 300 and from a laptop or laptop/PC 356, respectively, which may communicate with any or all of the components shown in FIG. 3. Note that while FIG. 3 illustrates hardware-implemented phone and computer selectors 352, 354, the selectors may be implemented in software using, e.g., a touch sensitive display. Moreover, one or more selectors may be provided on the case for gain control of audio playback.

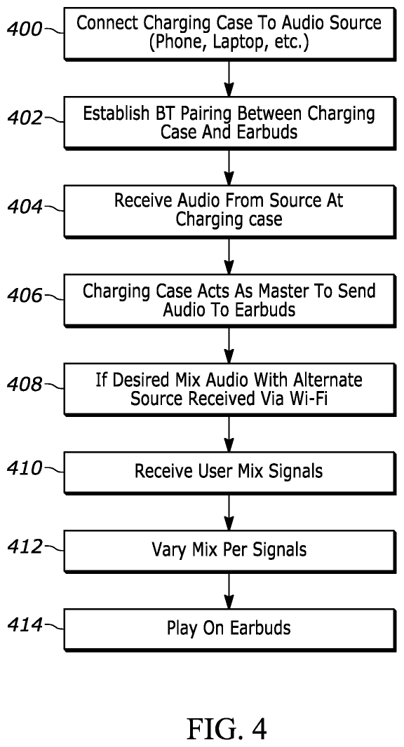

FIG. 4 illustrates that the charging case 208 advantageously may be employed not only to charge the earbuds 200 but also an audio device when connected to, for example, the laptop or PC 356 or other audio source. Note that the charging case 208 may be plugged into a universal serial bus (USB) connector on the phone 300 to receive audio therefrom. Note further that the logic in FIG. 4 may be performed by any processor herein including the charging case processor 346 alone or in cooperation with other processors described herein.

Commencing at block 400, the charging case 208 can be connected via wires or a wireless path to the audio source such as the laptop/PC 356 and/or phone 300. Block 402 indicates that a Bluetooth pairing or other near field communication pairing may be established between the earbuds 200 and wireless charging case 208.

Proceeding to block 404, the charging case 208 can receive audio signals from the source, e.g., the laptop 356 as well as from the phone 300. Note that earbud microphone signals can be sent to the laptop/PC 356 and/or phone 300 for playing signals from the earbud microphone on the laptop/PC speakers and/or phone speakers.

Moving to block 406, the charging case 208 can send the audio signals via Bluetooth or other communication link to the earbuds 200, allowing audio from the laptop 356 to be heard without having to pair the earbuds and laptop through Bluetooth and without disturbing any preexisting Bluetooth connections. In one embodiment, the charging case processor 340 may act as a master in sending audio signals to the earbuds. Or, the charging case 208 and earbuds 200 may all be connected to the phone 300 or charging case 208 and one of the earbuds 200 may act as master that connects to the phone 300 and feeds audio to the other components for mixing.

Block 408 indicates that if desired, audio from the laptop 356 or other source via, e.g., Wi-Fi may be merged with audio received from the mobile device 300. This mix may be effected by the earbud processor 328, for example or by the charging case processor 340. Moving to block 410, as the user manipulates the phone and computer selectors 352, 354 on the charging case 208 for increasing and decreasing the mix of audio played by the earbuds 200 from the mobile device 300 and from a laptop or laptop/PC 356, respectively, the mix is varied accordingly at block 412. The audio is played on the earbuds at block 414.

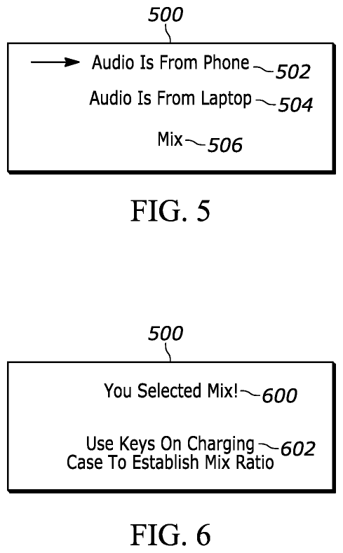

FIGS. 5 and 6 are example screen shots of example user interfaces that may be presented on any display 500 disclosed herein consistent with present principles.

In FIG. 5, three selectors are shown, ne for selecting to play audio on the earbuds sourced from the phone (at 502), one for selecting to play audio from the laptop 356 (at 504), and a third selector 506 for selecting to play a mix of audio from the phone and laptop. When the charging case 208 is the master, the selection is sent to the charging case to source the selected audio to the earbuds either from the charging case 208 direct to the earbuds or from the phone or laptop accessing the relevant files and controlled by the charging case processor 346.

Assuming the user selected a mix in FIG. 5, FIG. 6 so informs the user at 600 and advises the user at 602 to change the mix as desired by manipulating the phone and computer selectors 352, 354 on the charging case 208 for increasing and decreasing the mix of audio played by the earbuds 200 from the mobile device 300 and from a laptop or laptop/PC 356, respectively

While the particular embodiments are herein shown and described in detail, it is to be understood that the subject matter which is encompassed by the present invention is limited only by the claims.

What is claimed is:

1. An assembly, comprising:
left and right earbuds configured to engage the ears of a person for playing audio; and
a charging case configured for charging batteries in the left and right earbuds, the charging case comprising at least one processor configured with instructions to send to the earbuds, via at least one wireless interface, signals from a first source of audio representing audio for play of the audio on speakers of the earbuds.

2. The assembly of claim 1, wherein the first source of audio comprises a laptop computer.

3. The assembly of claim 1, wherein the first source of audio comprises a mobile telephone.

4. The assembly of claim 1, wherein the charging case is configured to mix audio from the first source of audio with audio from a second source of audio.

5. The assembly of claim 4, wherein the charging case comprises at least one selector operable by a user to establish the mix of audio.

6. The assembly of claim 1, wherein the charging case is configured to be communicatively connected to the first source of audio.

7. The assembly of claim 1, wherein the charging case is configured with first and second receptacles configured to closely hold the respective left and right earbuds.

8. A method, comprising:
charging left and right earbuds using at least one charging case configured with first and second receptacles configured to hold the respective left and right earbuds; and
providing wireless audio signals from the charging case to the earbuds for playing audio on the earbuds.

9. The method of claim 8, comprising establishing at least one wireless link between the charging case and earbuds.

10. The method of claim 9, wherein the wireless link comprises a Bluetooth link.

11. The method of claim 9, wherein the wireless link comprises a Wi-Fi link.

12. The method of claim 8, wherein the charging case receives audio signals from a first source of audio, and the method comprises:
mixing audio from the first source of audio with audio from a second source of audio to provide mixed audio; and
playing the mixed audio on the earbuds.

13. The method of claim 12, comprising:
establishing the mixed audio at least in part based on mix signals input to the charging case by a user.

14. A charging case comprising:
at least one contact electrically connected to a power supply in the charging case and configured to engage a contact on an earbud to charge a battery in the earbud; and
at least one audio signal path in the charging case for wirelessly sending audio signals to the earbud.

15. The charging case of claim 14, wherein the audio signal path comprises a Bluetooth transceiver.

16. The charging case of claim 14, wherein the audio signal path comprises a communication link to a first source of audio.

17. The charging case of claim 16, comprising at least one selector operable by a user to establish a mix of audio from the first source of audio with audio from a second source of audio for provision of the mix to the earbuds for playing thereon.

18. The charging case of claim 16, wherein the first source of audio comprises a laptop computer.

19. The charging case of claim 16, wherein the first source of audio comprises a mobile telephone.

20. The charging case of claim 14, comprising the earbuds.
